(19) United States
(12) Patent Application Publication
(10) Pub. No.: US 2014/0150005 A1
(43) Pub. Date: May 29, 2014

(54) CONTENT RECOMMENDATION PRE-FILTERING

(71) Applicants: CHAD KALMES, LAFAYETTE, CA (US); MARK JACOBSON, SAN FRANCISCO, CA (US); TIM LYNCH, SAN ANSELMO, CA (US)

(72) Inventors: CHAD KALMES, LAFAYETTE, CA (US); MARK JACOBSON, SAN FRANCISCO, CA (US); TIM LYNCH, SAN ANSELMO, CA (US)

(73) Assignee: MOBITV, INC., OAKLAND, CA (US)

(21) Appl. No.: 13/684,304

(22) Filed: Nov. 23, 2012

(51) Int. Cl. H04N 21/27

(52) U.S. Cl. CPC H04N 21/27
USPC 725/14

(57) ABSTRACT

Techniques and mechanisms described herein facilitate the performance of content recommendation pre-filtering. According to various embodiments, information identifying one or more viewing events or actions detected in association with a designated content management account at a media system may be received. The designated content management account may provide access to a plurality of media content items via the media system. The designated content management account may be associated with a viewing profile. The viewing profile may designate one or more of the plurality of media content items for recommendation in association with the designated content management account. The viewing profile may also designate a pattern of viewing activity for recommending the designated media content items. When the identified viewing events or actions match the designated pattern of viewing activity, a message including an instruction for recommending the designated media content items for presentation may be transmitted to the client machine.

### TECHNICAL FIELD

The present disclosure relates to the recommendation of media content items.

### DESCRIPTION OF RELATED ART

Content recommendation engines may be used to predict media content items that a user may be likely to enjoy. Many content recommendation engines rely upon mathematical algorithms to compute predictive models for content recommendation. The predictive models facilitate the selection of available but unviewed content items for recommendation to the user. Such selections are often based at least in part on the user's prior viewing habits. In many cases, however, developing an accurate recommendation for specific content may be difficult, such as when a user has viewed a relatively small amount of content or when the user's viewing history does not sufficiently match other users' viewing history.

### BRIEF DESCRIPTION OF THE DRAWINGS

The disclosure may best be understood by reference to the following description taken in conjunction with the accompanying drawings, which illustrate particular embodiments.

FIG. 1 illustrates an example of a method for recommending media content, performed in accordance with various techniques and mechanisms of the present invention.

FIG. 2 illustrates an example of a system that can be used with various techniques and mechanisms of the present invention.

FIG. 3 illustrates an example of a media content preference data and recommendation chart.

FIG. 4 illustrates an example of a method for media content recommendation profiles.

FIGS. 5A-5C illustrate examples of charts depicting pre-treated data.

FIG. 6 illustrates an example of a method for post-processing recommendation data.

FIGS. 7-9 illustrate examples of systems.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

Techniques and mechanisms described herein facilitate the recommendation of media content items. Many content recommendation engines rely upon mathematical algorithms to compute predictive models for content recommendation. The predictive models facilitate the selection of available but unviewed content items for recommendation to the user. Such selections are often based at least in part on the user's prior viewing habits. According to various embodiments, recommendation systems described herein may employ a two-phase approach. First, a recommendation system may perform offline, complex calculations on large volumes of data to present baseline recommendations. Then, the recommendation system may supplement this baseline data with branching options in real-time or near real-time based on ongoing user interactions. The recommendation system may be used to react quickly to user actions, supplying updated or tailored recommendations that reflect both a user's past viewing history and the user's recent viewing patterns.

### EXAMPLE EMBODIMENTS

According to various embodiments, users may receive content from a content management service. The content management service may facilitate the interaction of users with various types of content services. For instance, the content management service may provide a user interface for managing and accessing content from a number of different content sources. The interface may display content received via a cable or satellite television connection, one or more on-demand-video service providers such as Netflix or Amazon, and content accessible on local or network storage locations. In addition, the interface may be used to access this content on any number of content playback devices, such as televisions, laptop computers, tablet computers, personal computers, and mobile phones.

According to various embodiments, a media content recommendation engine may include one or more algorithms or formulas for recommending content. The media content recommendation engine may, for example, compute matrix factorizations and permutations based on information such as preference and viewing history information associated with a user account. These computations may be used to match users with media content that they have not yet watched.

According to various embodiments, various types of information may be used as inputs to create media content recommendations for users. In some cases, a user may expressly indicate preferences regarding media content, such as by rating a media content item or indicating that a media content item is liked or disliked. In other cases, a user may implicitly indicate preferences regarding media content. For example, a user may exhibit a pattern of watching westerns, dramas, or programs that involve particular cast members or directors. As another example, a user may tend to request to view detailed information regarding particular types of content.

According to various embodiments, many content recommendation techniques involve matching a user's historical content interaction to the factorized historical interactions of other users. Based at least in part on this matching, the recommendation system may produce a list of media content items to recommend to the user. Each of the media content items in the list may be assigned a ranking relative to other items in the list. The ranking may reflect the strength of the recommendation and/or the degree of certainty with which the user is expected to enjoy the recommended media content item. For instance, a media content item that is a better match to the user's viewing history and preferences than another media content item may be assigned a relatively higher ranking.

According to various embodiments, a media system may be implemented at least in part via a large, distributed computing environment. In general, the complexity of the recommendation procedure is positively correlated with the quality of the media content recommendations that are produced. Thus, providing accurate and timely media content recommendations that are personalized to the end-user may be a relatively costly operation from the standpoint of computing resource utilization. Providing such recommendations may involve a significant amount of data mining that requires too much information and too many computing resources to be performed at a client machine or in an offline environment. Accordingly, at least some of the recommendation process occurs when a user is not interacting with the media content service and may be based on information such as the user's prior interactions with the service as well as other users' interactions with the service. This phase of the recommendation process may identify to a high level of accuracy the content that a user is most likely to enjoy.

However, offline, back-end recommendation analysis techniques alone cannot account for real-time demands and the spontaneous nature of what a user may be interest in at any given point of time. According to various embodiments, the overall recommendation engine may include the ability to react dynamically, for instance within a set of pre-determined viewing profiles, to offer up alternative content recommendations based on current user actions. The recommendation engine may include a front-end component that can receive real-time or near real-time inputs from the end user and translate them into rapid adjustments to the current list of recommendations. Then, the received inputs may be sent back to the offline, back-end numerical modeling system for recompilation into the master dataset so that updates and adjustments can be made periodically or occasionally to the baseline recommendation analysis. When the baseline recommendation analysis incorporates these inputs, the recommendations may be returned with updated branching alternatives, and the process can begin again.

For example, based on a user's past viewing history and preference information as well as any other information available to the recommendation engine, numerical modeling techniques may identify two separate viewing patterns associated with a content management account. The first viewing pattern may correspond to content such as sports, news, and entertainment. The second viewing pattern may correspond to cartoons and other children's content. These viewing patterns may reflect different viewers using the same content management account or different taste patterns associated with the same viewer. When these patterns are modeled, the recommendation engine may generate two separate recommendation sets which can be separately presented to the user, such as by genre tags. Then, the user can select a profile or content type to explore. Alternately, the user's current viewing mode may be dynamically determined based on the user's content choices. For instance, the system may detect that the user has selected a children's program and then, based on this selection, provide recommendations selected based on the second viewing pattern.

As another example, a user may exhibit viewing behavior that does not correspond with any viewing pattern associated with the user's content management account. For instance, the user may be new to the system and may have little or no viewing history or preference data associated with his or her content management account. Alternately, the user may suddenly begin viewing content that is quite different from the user's past activity, such as would be the case if an adult turned over control of the selection of content to a child. In such situations, the recommendation system may compare the viewer's recent content selections to profiles determined primarily or entirely from viewing history and preference information associated with other content management accounts. For example, a content management account may have a long viewing history composed entirely content normally associated with adults, such as sports, news, and dramatic films. Then, the content management account may suddenly be associated with the selection of children's content, such as Disney films. Since in this situation the content management account is not associated with viewing history information that is relevant to the most recent content selections, these most recent content selections may be compared instead with the viewing patterns of other accounts that do tend to watch children's content. Then, the recommendations may be dynamically updated based on the most recent content selections, often before the system has had the opportunity to refactor the baseline content recommendations.

Various viewing patterns may be determined when calculating the baseline recommendations. Then, the logic of making the last-minute adjustments for the borderline content may be made lightweight and flexible enough so that the content recommendations can be adjusted based on very recent viewing patterns. These last-minute recommendation adjustments may be made based on relatively simple, deterministic server-side calls or client-side calls, so that up-to-date recommendations can be displayed to the end user based on the user's recent actions.

According to various embodiments, the system may employ a back-end component that refactors the base dataset when necessary to incorporate user viewing history and preference information into the set of baseline recommendations. The system may also employ a front-end component that maintains a recommendation action buffer for adapting to a user's current viewing patterns. In particular embodiments, pre-filtering and post-processing recommendation data may allow a media system to update recommendations to end users based on their most recent interactions with the service. At the same time, processing-intensive calculations, such as re-calculating baseline recommendations, may be performed less frequently.

According to various embodiments, pre-filtering and post-processing recommendation data may allow a media system to create more accurate content recommendations for its users. In some cases, users may experience higher levels of engagement with the media system and/or increased content consumption. Alternately, or additionally, user preferences may be inferred without requiring that the user expressly indicate a preference regarding a content item. Accordingly, users may enjoy higher levels of satisfaction with the content access and management services provided by the media system.

According to various embodiments, some or all of various types of input information may be weighted based on various criteria. Weighting the input information may in some cases improve the validity and relevance of the data sets returned from increasingly large and complex series of usage statistics. Additionally, or alternately, weighting the input information may provide increasing quality of experience and better targeting of returned results from the searched data. In particular embodiments, the types of weights that may be applied to the input information may be strategically determined based on factors such as the observed behaviors of the users interacting with the system.

According to various embodiments, a weighting factor may be used to treat a data point different during numerical modeling. For example, a positive weighting factor may render a data point more significant during modeling, while a negative weighting factor may render a data point less significant. As another example, a weighting factor greater than one may render a data point more significant during modeling, while a weighting factor between zero and one may render a data point less significant. The precise effect of weighting factors may be strategically determined based on factors such as the type of numerical modeling being performed.

According to various embodiments, the model may be implemented in terms of percentage weighting, integer weighting, real number weighting, weighting on a range of numbers, or any other weighting scale. In particular embodiments, the model is not based on fixed weighting values, but rather is flexible and adjustable so that it can be refined and tweaked to provide improved content recommendation results over time. For instance, the relevance of returned results can be monitored and surveyed to improve the system with new data. For example, in the case of percentage weighting, a single view of a piece of content may yield a weighting value of 100%, 90%, 110%, or any other value. Multiple repeated views may be weighted at 100% relevance, 150% relevance, or any other value. Moreover, those rating values may be altered dynamically over time to improve the recommendation results.

According to various embodiments, techniques and mechanisms described herein may facilitate the adjustment of media content item rankings within a media content item recommendation list. In particular embodiments, a content recommendation technique may produce a potentially large number of rank-equivalent or approximately rank-equivalent recommendations. It is anticipated that many users, such as users with similar historical content interactions, may share similar recommendation lists that include similar sets of rank-equivalent recommendations. In such cases, the relative success of recommendations provided to users with similar or approximately rank-equivalent recommendation sets may be compared. Success for a recommendation may be based on whether the recommendation tends to be selected for playback by users, whether the recommendation meets a success criteria threshold, whether the recommended item tends to receive positive or negative reviews, or various other criteria. Recommendations that are considered successful for users provided with similar content recommendations may be increased in relative ranking in future recommendation sets for other users. Similarly, recommendations that are considered unsuccessful for users provided with similar content recommendations may be decreased in relative ranking in future recommendation sets for other users.

Many of the recommendation techniques are described herein with reference to content items. The recommendation techniques described herein are widely applicable to a variety of content divisions. For example, a media content item may be an individual piece of content such as a video object. As another example, a media content item may be a standardized content channel such as a television channel or a personalized content channel created by the media system. As yet another example, a media content item may be a content category such as a genre. Also, although content may be referred to herein as video content, the techniques and mechanisms described herein are generally applicable to a wide range of content and content distribution frameworks. For example, the content may be media content such as video, audio, or image content.

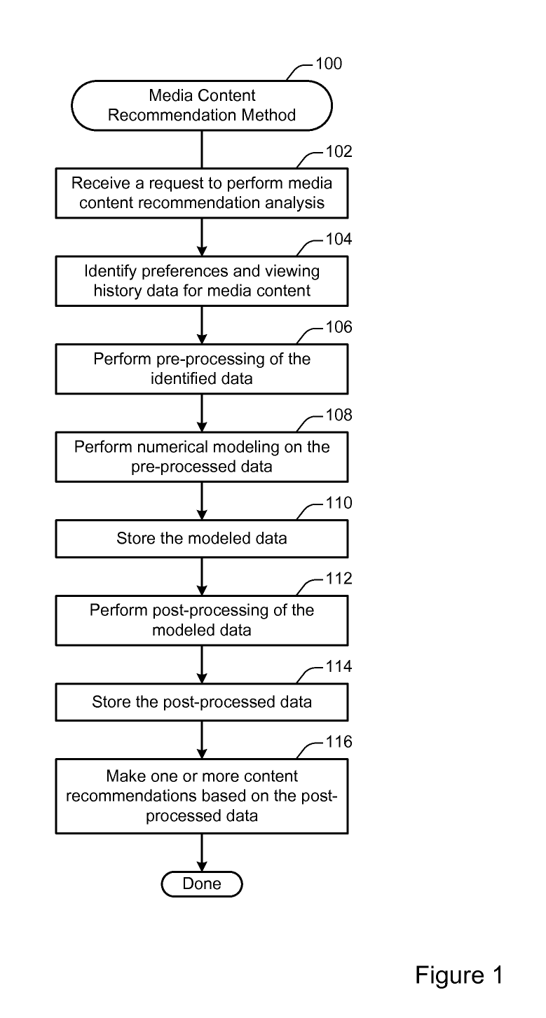

FIG. 1 illustrates an example of a method 100 for recommending media content, performed in accordance with various techniques and mechanisms of the present invention. According to various embodiments, the method 100 may be performed at a media system or at any other computing system capable of performing media content analysis.

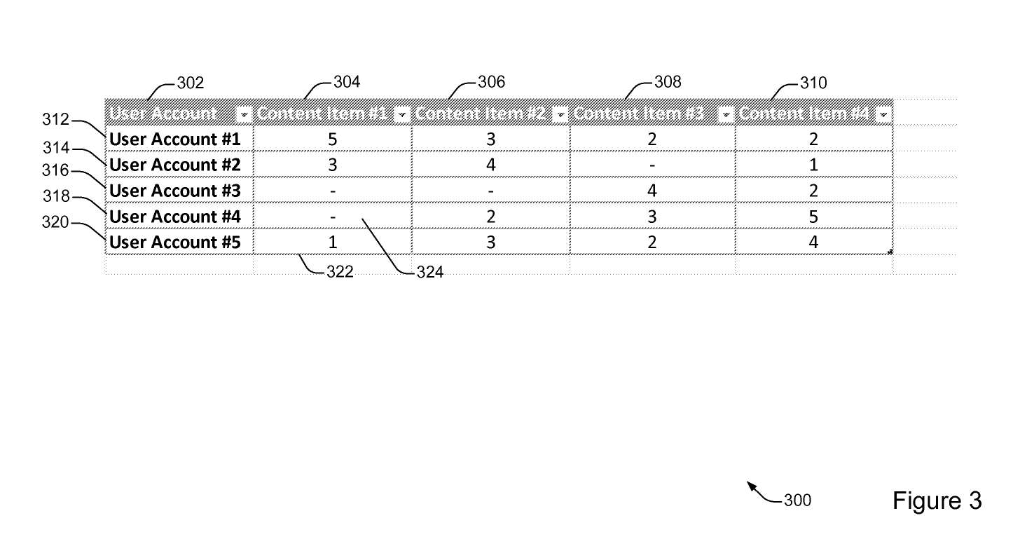

In particular embodiments, the method 100 may be used to estimate preferences for media content items. Content preferences and viewing history information associated with a user account may be combined with similar information associated with other user accounts. Then, the resulting data may be processed, analyzed, and modeled to estimate preferences for content that has not yet been presented in association with a content management account. The estimated preferences may be used to formulate recommendations for content items that a user or users associated with a content management account might like to view. One example of the type of data that may be analyzed and/or created in conjunction with the method 100 is shown in FIG. 3.

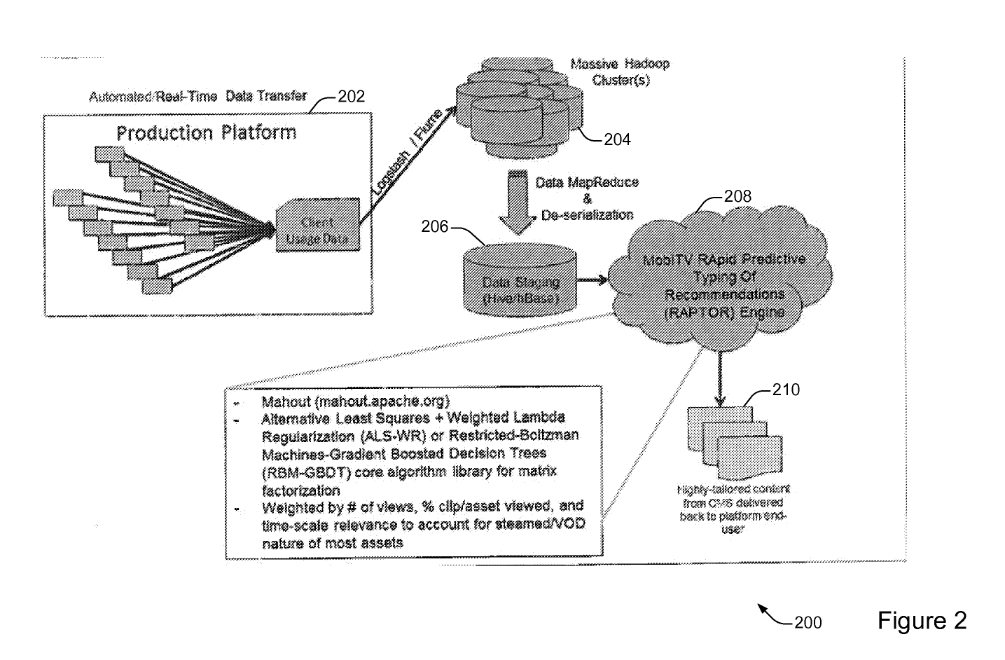

At 102, a request to perform media content recommendation analysis is received. According to various embodiments, the request may be received at a media system such as the media systems discussed with respect to FIGS. 2, 7, and 8. Alternately, or additionally, the request may be received at a different computing system such as an on-demand or cloud computing system accessible via a network such as the Internet.

According to various embodiments, the request may be generated based on any of a variety of triggering events. For example, a user may initiate a request to perform the media content recommendation analysis. As another example, the request to perform the media content recommendation analysis may be automatically generated based on a triggering event. For instance, the request may be generated when a sufficient amount of new preference or viewing history data has been received, when a sufficient number of new users are added to the system, or when a designated time period has elapsed since media content recommendation analysis has last been performed.

In particular embodiments, the request may be generated based on a scheduled or periodic triggering event. For instance, media content recommendation analysis may be performed a designated number of times (e.g., once, twice, etc.) every minute, hour, day, week, month, or any other time interval. According to various embodiments, the frequency with which media content recommendation analysis is performed may be strategically determined based on a variety of factors that may include, but are not limited to: the amount of data being analyzed, the types of data being analyzed, the computing resources available, the type of analysis being performed, the frequency with which new content is added to the system, and the quality of the resulting recommendations. For example, in some systems new content is added daily, so the method 100 may be performed on the order of once per day. In other systems, new content such as short video clips is added continuously, and at least some of the content may include time-sensitive information such as weather reports. In these systems, the method 100 may be performed more frequently.

At 104, preference and viewing history data for media content is identified. According to various embodiments, the data identified at operation 104 may include any information relevant to forming an estimate of user preferences regarding media content. The data may include, but is not limited to: content items viewed, content categories or genres viewed, dates and/or times when content was viewed, preferences expressed regarding content items, content channels, or content categories, percentages or other quantifiers for the amount of a content item that was viewed, the number of times a content item or category was viewed, a location at which a content item was viewed, and the device or devices at which a content item was viewed.

At 106, one or more operations related to pre-processing the identified data are performed. According to various embodiments, pre-processing may include any operations related to selecting, filtering, sorting, updating, weighting, analyzing, or otherwise treating the data prior to the performance of the primary numerical modeling used to estimate preferences. For instance, pre-processing may involve weighting the viewing history and content preference data by time, by a number of views, by percent-consumed, and/or by other factors.

In particular embodiments, pre-processing the identified data may be used to emphasize a particular attribute or attributes for relevance. For instance, viewer preferences regarding some types of media content items such as news reports may be sensitive to time of day. That is, users may wish to view news reports in the morning or evening, but not during the middle of the day. Accordingly, pre-treating may be used to emphasize an attribute of the viewing data, such as time of day, that may be particular relevant in some or all contexts.

At 108, numerical modeling is performed on the pre-processed data. According to various embodiments, the numerical modeling may analyze the pre-processed data to estimate preferences for content. In particular embodiments, preferences may be estimated for content items that have not yet been presented in association with a content management account. Alternately, or additionally, preferences may be estimated for content that has been presented, such as content that has been viewed but that was not rated. In many systems, numerical modeling is a computationally complex task that requires a relatively large amount of computing resources. For instance, numerical modeling may require the computation of matrix operations for large matrices or other such time-consuming tasks.

According to various embodiments, various types of numerical modeling may be performed. The modeling techniques may include, but are not limited to: log-likelihood techniques, Pearson correlation, Rocchio Relevance Filtering, k-nearest neighborhood, Slope One, collaborative filtering techniques, content-based filtering techniques, hybrid recommender techniques, Bayesian Classifiers, cluster analysis, Alternative Least Squares with Weighted Lambda Regularization, Restricted-Boltzman Machines-Gradient Boosted Decision Trees or other types of decision tree techniques, and artificial neural networks. The choice of modeling techniques may depend on factors such as the type of data being analyzed and the type of analysis being performed. In particular embodiments, modeling techniques may be strategically determined based on the factors such as the relative efficacy of different techniques when applied to a particular media system, user base, and/or data set.

At 110, the modeled data is stored. According to various embodiments, the modeled data may be stored on a storage medium within or accessible to the media system. The modeled data may be stored so that it may be retrieved to provide content recommendations and/or to perform post-processing of the modeled data. In particular embodiments, different types of post-processing may be performed on a modeled data set. Accordingly, the modeled data may be stored so that it can be retrieved separately for performing different types of post-processing.

At 112, post-processing of the modeled data is performed. According to various embodiments, post-processing of the modeled data may include any operations related to selecting, filtering, sorting, updating, weighting, analyzing, or otherwise treating the data after the performance of the primary numerical modeling used to estimate preferences.

In particular embodiments, post-processing of the modeled data may be performed to update or edit the data for providing feedback for the next iteration of the media content recommendation process 100. For instance, new media content preferences or viewing history information may be received. This information may be used to update the data identified at operation 104. Alternately, or additionally, the new information may be used to check the validity of the recommendations produced by the numerical modeling or post-processing operations. For example, a user may view and/or indicate a preference for a media content item recommended to the user. This information may be used as positive feedback, positively reinforcing the process or data that led to the recommendation. As another example, a user may not view or may indicate a preference against a media content item recommended to the user. This information may be used as negative feedback, negatively reinforcing the process or data that led to the recommendation.

In particular embodiments, post-processing of the modeled data may be performed to provide updated recommendations based on new information. For instance, new viewing history or content preference information may be received after numerical modeling is performed at operation 108 but before the method 100 is performed again. As discussed herein, numerical modeling is in many systems a computationally complex task that requires a relatively large amount of computing resources. Post-processing may allow the recommendation system to provide updated recommendations based on new information without incurring the relatively large computational costs associated with full numerical modeling of the data set. For example, post-processing may involve numerical modeling that uses as input a limited subset of data rather than a complete data set. As another example, post-processing may involve a simpler form of numerical modeling that is less computationally intense than that employed in operation 108.

In particular embodiments, post-processing of the modeled data may be performed to provide media content recommendations for new users of the recommendation system. For example, the recommendation method 100 may be performed on a daily basis. After the method is performed, a new user may join the system and view several pieces of content in the first day, before the next iteration of the recommendation method 100. In this case, post-processing may be used to provide the new user with content recommendations even before the next iteration of the recommendation method 100. Because the post-processing recommendation process may be less complete than the full numerical modeling performed at operation 108, the post-processing procedure may provide provisional recommendations that are improved upon by the next iteration of the numerical modeling process.

In particular embodiments, post-processing of the modeled data may be performed to provide media content recommendations for different viewing patterns associated with a single content management account. In one example, a content management account may be used by different members of the same family. The father may use the account to view sporting events, while children may use the account to view Disney movies. Accordingly, the recommendation engine may recommend a variety of media content items that reflect the family members' varied tastes in content. These recommendations may be refined via post-processing based on recent viewing history. For instance, if the account is being used to watch a basketball game, then the recommendations shown after the basketball game is viewed may be for other sporting events. If instead a pattern of Disney movie viewing is detected, then post-processing may be used to refine the media content recommendations to select those that match this viewing pattern.

In another example, a viewing pattern associated with a content management account may change abruptly. For instance, the content management account may be primarily used to view content typically enjoyed by adults, such as sporting events and news broadcasts. However, the viewing pattern may suddenly change to cartoons, such as when an adult hands a content playback device such as a tablet computer to a child. Even though this viewing pattern does not match the pattern associated with the content management account, post-processing may be used to recommend other content related to these recent viewing choices, such as other cartoons.

At 114, the post-processed data is stored. According to various embodiments, the storing of the post-process data may be substantially similar to the storing of the modeled data discussed with respect to operation 110. The post-processed data may be stored in any way that makes it accessible to the recommendation for providing content recommendations and performing other analysis. The post-processed data may include, for potentially many different content management accounts, estimated preferences for potentially many different media content items. One example of the type of data that may be analyzed, created, and stored in conjunction with the method 100 is shown in FIG. 3.

At 116, one or more content recommendations are made based on the post-processed data. According to various embodiments, the content recommendations may be provided to a client machine associated with a content management account. The content recommendations may be personalized according to the viewing history and content preferences of the content management account. The recommended content may be available via any content source that is accessible to the content management account. In particular embodiments, the recommended content may be available for presentation at any of a variety of content playback devices associated with the content management account.

According to various embodiments, content recommendations may be made based on one or more of a variety of factors. For example, content may be selected based on an estimate of the degree to which the content matches the viewing history and content preferences of the content management account, as discussed with respect to operations 102-114. As another example, more time-sensitive content such as live sporting events may be more likely to be selected than less time-sensitive content such as old movies.

According to various embodiments, one or more of the operations shown in FIG. 1 may be omitted. For example, in some instances pre-processing or post-processing of the data may be omitted. As another example, in some instances modeled data may not be stored separately from post-processed data.

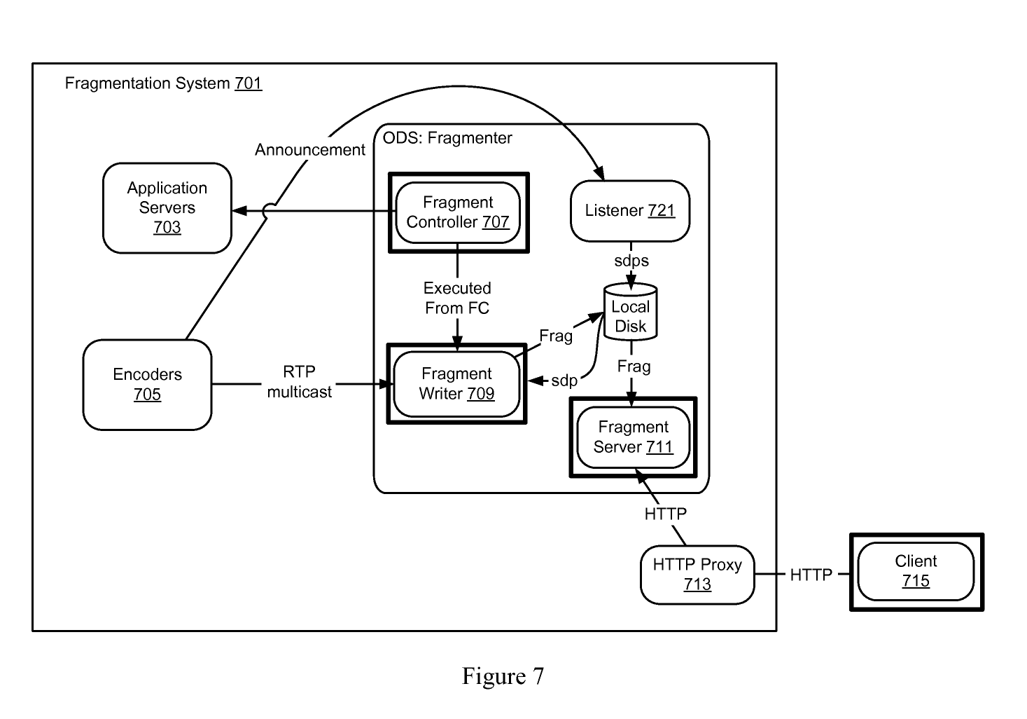

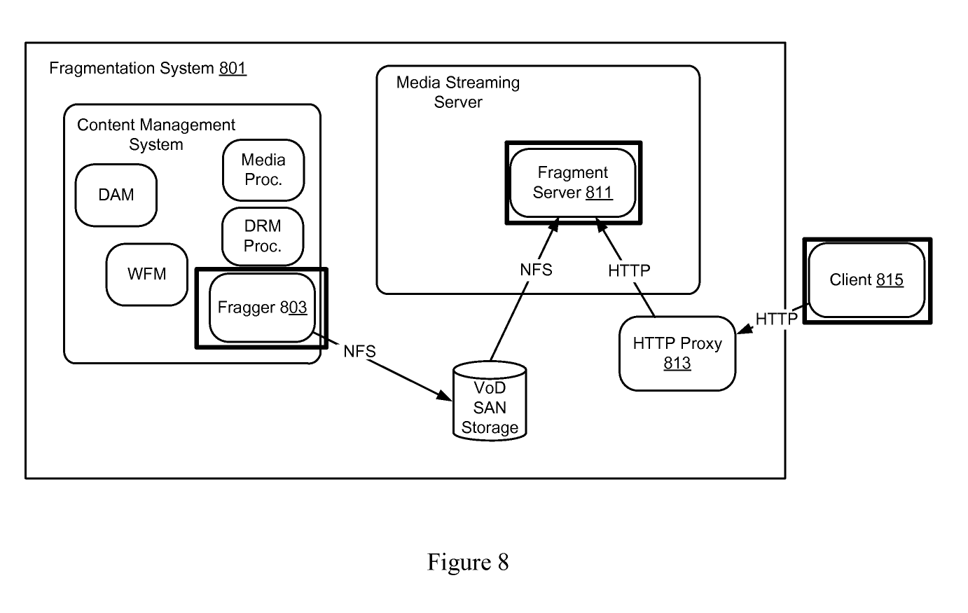

FIG. 2 illustrates an example of a system 200 that can be used with various techniques and mechanisms of the present invention. According to various embodiments, the system shown in FIG. 2 is a recommendation system that may be used to receive, analyze, and process data for providing media content recommendations. The system 200 includes a production platform 202, Hadoop clusters 204, a data storage system 206, a recommendation engine 208, and content items 210. The system 200 is presented at an abstract level, and many hardware and software components that may be present in a recommendation system are omitted for clarity. Various hardware and software components of systems, including components that are not shown in FIG. 2, are discussed with respect to FIGS. 7 and 8.

According to various embodiments, the production platform 202 is used to provide media content for presentation in association with many different content management accounts, each of which may be associated with potentially many different content playback devices. The production platform 202 may also be used to collect and aggregate client usage data. The client usage data may identify media content preference and viewing history information associated with the presentation of the content. For instance, when a user views a media content item, indicates a liking or disliking of a media content item, or selects a recommended content item for presentation, such information may be stored for analysis.

According to various embodiments, the one or more Hadoop clusters at 204 constitute a distributed computing system that allow potentially many different computers to coordinate while analyzing a potentially very large data set. The Hadoop clusters may be used to perform various types of data analysis such as MapReduce and deserialization. Although the system 200 uses Hadoop clusters, other recommendation systems may employ other hardware and/or software frameworks for data analysis. These frameworks may include, but are not limited to: columnar oriented database systems such as Cassandra, commercial large data systems such as Teradata, and open source relational databases such as Postgres.

According to various embodiments, the data staging system 206 may be used to store data for use in conjunction with the Hadoop clusters 204. For instance, the data staging system 206 may store an HBase database in a Hive data warehouse system. Alternately, the data staging system 206 may employ a different data storage and/or management system.

According to various embodiments, the recommendation engine 208 may be used to process the staged data for providing media content recommendations. The recommendation engine 208 may be used to perform any of a variety of operations related to recommendation. For example, the recommendation engine 208 may be used to perform a machine learning algorithm such as an algorithm performed via the Apache Mahout framework. As another example, the recommendation engine 208 may be used to perform numerical modeling, as discussed with respect to operation 106 shown in FIG. 1. As yet another example, the recommendation engine 208 may be used to perform pre-processing operations such as weighting viewing history and/or content preferences by a number of views, by a percentage or amount of a content item that was viewed, by the date or time when a content item was viewed, or by some other factor.

According to various embodiments, the content recommendations at 210 may be selected based on the analysis performed at the recommendation engine 208 or elsewhere in the recommendation system. The content recommendations may be provided to a user of a content playback device associated with a content management account. Based at least in part on the content recommendations, a user may select content for presentation on the content playback device or on another device. Providing content to the content playback device may be performed via the production platform 202. Additionally, information regarding media content preferences and viewing history related to the content recommendations provided at 210 may be stored as client usage data in the production platform 202 and used to provide updated media content recommendations.

FIG. 3 illustrates an example of a media content preference data and recommendation chart 300. According to various embodiments, the chart 300 includes information regarding media content preferences and viewing history for various user accounts. The chart 300 includes the content item columns 304-310, the user account column 302, the user account rows 312-320, and the content preference data cells 322 and 324.

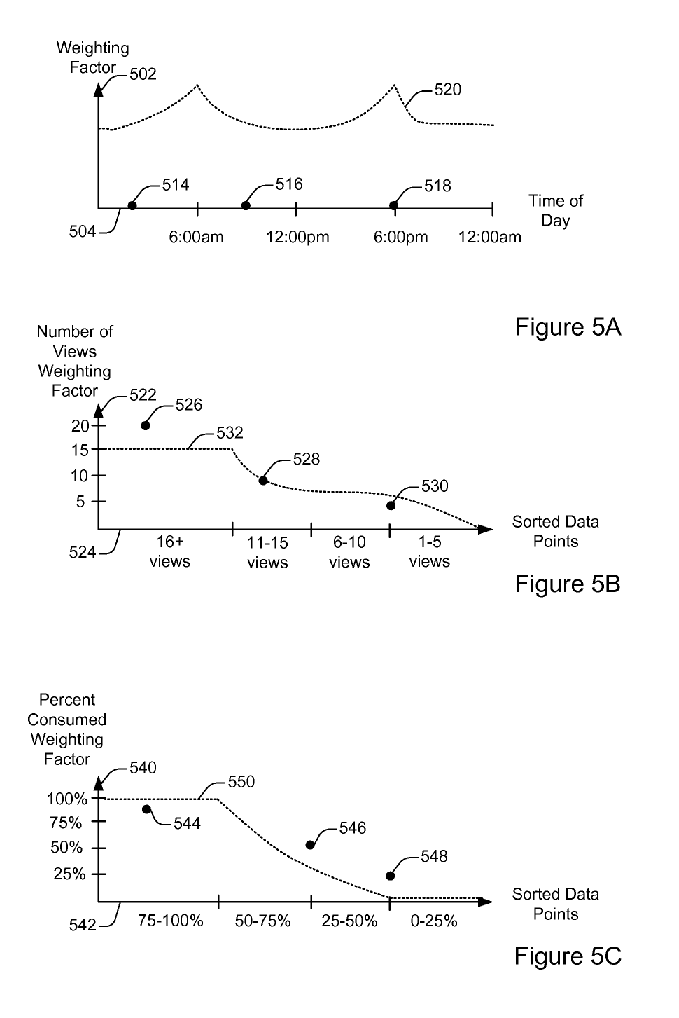

According to various embodiments, the user account column 302 includes identifiers for user accounts. User accounts are also referred to herein as content management accounts. Each user account may be associated with one or more users of a content management system. Although only five user accounts are shown in FIG. 5, an actual data set may include any number of user accounts. For instance, many data sets include hundreds of thousands or millions of different accounts.

According to various embodiments, the content item columns 304-310 are each associated with a different media content item or content category. Each of the media content items may be analyzed by the recommendation system for the purposes of providing recommendations to the user accounts. In particular embodiments, not all of the media content items may be available to each user account. For instance, users of the media recommendation system may receive content from different sources, such as broadcast television and on-demand services such as Netflix. In this case, some users may have access to some content sources but not to other content sources.

According to various embodiments, each of the user account rows 312-320 includes a number of content preference data cells that correspond to different content items. Content preference data cells may be used to store any of various types of information. This information may include, but is not limited to: expressed preferences regarding a content item (e.g., a number of stars), a percent consumed of a content item, a location at which a content item was viewed, a date or time at which a content item was consumed, and a number of times that a content item was viewed.

According to various embodiments, various types of values may be stored within each of the media content data cells. For example, the data cell 322 stores a “1”, which may indicate an expressed preference, a percent consumed, or some other viewing history or content preference information related to the first content item 304. As another example, the data cell 324 is blank, indicating that the content item has not yet been viewed in association with the fourth user account 318. As yet another example, data cells may be updated to include estimated values calculated by the media recommendation system.

According to various embodiments, the media recommendation system may calculate estimated values for any or selected ones of the blank data cells. For instance, the media recommendation system may calculate estimated values for all blank data cells associated with a user account, for all blank data cells associated with a user account, for all blank data cells associated with content items to which a user account has access, or for any other set of data cells.

According to various embodiments, media content preference and recommendation data may appear significantly different than the chart 300 shown in FIG. 3. For instance, in some techniques, specific data value estimates may be created for unviewed content items. Alternately, or additionally, data value estimates may be stored as differences between pairs in a sparse matrix, which may facilitate the rapid calculation of data value estimates for newly added content items.

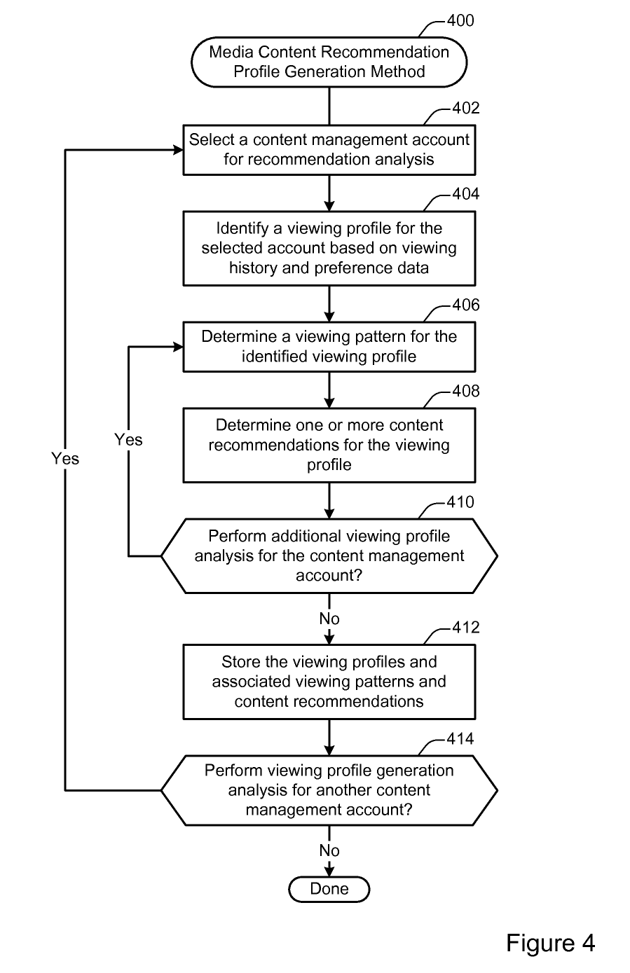

FIG. 4 illustrates an example of a method 400 for generating media content recommendation viewing profiles. According to various embodiments, the method 400 may be performed at a media system. The method 400 may be performed in conjunction with numerical modeling, as discussed with respect to operation 108 in FIG. 1. The method 400 may be used to analyze viewing history or preference data to create one or more media viewing profiles that each reflect a viewing pattern associated with a content management account

According to various embodiments, the method 400 may be used to generate one or more viewing profiles that may be activated when particular viewing patterns are detected. For instance, recommendations of content items may be provided to a viewer viewing content in association with a content management account if the viewing activity matches a profile. These media content recommendations may be generated by a recommendation engine, as discussed with respect to FIG. 1.

According to various embodiments, media content recommendation profiles may be generated in order to provide a dynamic recommendation experience that can quickly adapt to events or viewer actions. As discussed with respect to FIG. 1, numerical modeling to compute baseline recommendations may be performed periodically or occasionally rather than immediately after each newly detected event or user action. For instance, numerical modeling may be performed once per day, when a triggering event is detected, or according to some other schedule. By generating viewing profiles that include content recommendations that can be provided to users based on information that is received in between iterations of the numerical modeling, the recommendations provided to viewers can be quickly updated. For instance, if a viewer selects sports-related content for viewing, a viewing profile may be triggered whereby the viewer is provided with recommendations for other sports-related programming even if the baseline content recommendations for the viewer have not yet been recalculated.

At 402, a content management account is selected for recommendation analysis. Each content management account may be associated with viewing history or content preference data. The data for each content management account may identify potentially many different content items or content categories that have been viewed in association with the account. The data may include information such as which content items have been viewed, how much of each content items has been viewed, any expressed or inferred ratings for the content items, and any other type of data.

According to various embodiments, some or all of the content management accounts may be selected for profile generation. Content management accounts may be selected based on various factors. For example, a content management account may be selected because it is associated with a relatively large amount of viewing history and preference data, which may allow the recommendation engine to generate accurate viewing profiles. As another example, a content management account may be selected because it is associated with a relatively small amount of viewing history and preference data, which may increase the need for identifying different viewing profiles associated with the account.

In particular embodiments, a content management account may be selected because it is associated with viewing history or preference data that is indicative of different viewing profiles. For instance, an account may be associated with content viewing history information that indicates that the account has been used to view children's content such as cartoon movies. At the same time, the account may be associated with information that indicates that it has been used to view more mature content, such as dramatic television programs. Such an account may be a good candidate for generating different viewing profiles.

At 404, a viewing profile is identified for the selected account. According to various embodiments, the viewing profile may be identified based on viewing history and preference data. For instance, numerical modeling may be used to identify commonalities or patterns within the viewing history or preference data associated with the content management account.

According to various embodiments, viewing history or preference data for a user account may include commonalities or patterns that reflect different trends or modes of viewing. For instance, a single content management account may be associated with data that describes past viewing behavior for different types of content. For example, the account may have been used to view comedic and dramatic films, popular television shows, children's movies, news broadcasts, and sports programming These content item views may be arranged chronologically. For instance, content items that are viewed close together in time may be grouped together for analysis.

According to various embodiments, grouping views of content items chronologically may reveal trends or viewing modes. For instance, when the account is used to view news broadcasts, it may most often next be used to view other news broadcasts, sports programming, or popular television shows. However, when the account is used to view news broadcasts, it may rarely be used next to view children's programming or comedic and dramatic films. Accordingly, the past usage of the account to view news broadcasts reveals a trend or pattern of viewing.

The same content management account may also be associated with another profile centered on children's viewing preferences. For instance, when the account is used to view children's programming, subsequent selections of content items may be primarily chosen from other children's programming or comedic films, but rarely sports or news broadcasts.

The same content management account may also be associated with yet another profile centered on movie viewing preferences. For instance, when the account is used to view dramatic films, the account may most often be next used to view other dramatic films, and rarely used then to view children's programming or news and sports broadcasts.

According to various embodiments, each of these viewing profiles may be associated with one or more individuals. For example, a household may include two adults who tend to watch dramatic films together, which may give rise to a first profile. In this example, one of the adults but not the other may often view sports programming, which may give rise to a second profile. The household may also include two children who tend to watch children's programming together, which may give rise a third profile. Finally, the members of the household may view some content all together, such as comedic films, which may give rise to a fourth profile. The content recommendation system may or may not have information for identifying the different individuals associated with different profiles.

According to various embodiments, a single individual may be associated with potentially many different profiles. For instance, a viewer may sometimes tend to view comedies while at other times may tend to view news or sports. These viewing trends may be separated into different profiles. In this way, if the viewer selects for viewing some content item or items that match a predetermined profile, the recommendation system may quickly adapt to the selection, providing the viewer with recommendations of other content items that reflect the viewer's current or recent viewing activity patterns.

In particular embodiments, a viewing profile may be associated with a time of day. For instance, the account may often be used to watch news broadcasts in the morning and sports-related programming in the late evening. By associating a profile with a time of day, the media system may more easily recognize when viewing activity reflects a particular viewing profile.

At 406, a viewing pattern for recommending the identified viewing profile is determined. According to various embodiments, the condition may be determined by identifying which actions or events would need to occur for the viewing profile to become relevant to a viewer or viewers associated with the content management account based on the viewing history and preference data associated with the account. For instance, numerical analysis may indicate that if the viewer were to perform or not perform a particular action or actions, or if a designated event or events were to occur, then the viewer is likely operating in a particular viewing profile.

According to various embodiments, the viewing pattern may indicate one or more events or actions that, if they are detected, would cause the media system to recommend media content associated with the identified viewing profile. For example, the viewing pattern may indicate the types of content that would need to be select for the identified viewing profile to be used to recommend content. As another example, the condition may indicate a portion or percentage of a content item that needs to be viewed for the viewing profile to be employed. As yet another example, the pattern may indicate other types of actions or events that need to occur, such as a designated time of day, for the activation of the identified viewing profile.

In particular embodiments, the viewing pattern may be associated with a baseline or default viewing profile. For instance, a particular content management account may be associated with a relatively heterogeneous baseline viewing pattern that reflects the combined viewing preferences of an entire family of viewers who share access to the account. Then, different family members may be associated with more specific viewing profiles that match the viewing activity when only one of the family members is viewing content. The baseline viewing pattern may be selected for use in recommending content items when no more specific viewing pattern seems to match the viewing activity. Alternately, or additionally, some amount of content recommendations derived from the baseline viewing profile may be provided even when a more specific profile is being used. In this way, a viewer may be provided with specifically tailored content recommendations while at the same time, other non-specific recommendations may be provided in case the original viewer is joined or replaced by other family members.

At 408, one or more content recommendations for the viewing profile are determined. According to various embodiments, the one or more content recommendations may be determined by performing numerical modeling based on the viewing history and preference data associated with the content management accounts as well as data associated with other accounts. Numerical modeling to select content items for recommendation is discussed in further detail with respect to FIG. 1.

In particular embodiments, the viewing pattern may indicate that the viewer selecting content in association with the content management account is operating in a particular viewing mode. For instance, a particular viewing profile and pattern may be generated to provide a viewer with additional comedy-related content if the content system determines that the viewer is watching comedies, since a viewer who is watching comedy programming may be especially likely to enjoy watching other comedy-related content.

In particular embodiments, the recommendations may be determined by performing numerical modeling while omitting viewing history and preference data not associated with the identified viewing profile. Alternately, numerical modeling may be performed with all viewing history and preference data, and recommended content items related to the viewing profile may be selected.

At 410, a determination is made as to whether to perform profile generation analysis for the selected content management account. According to various embodiments, various criteria may be used to make the determination. For example, a designated threshold may identify or limit the number of profiles that are generated in association with a content management account. As another example, a designated threshold may identify a level of relevance or commonality for generating a profile based on viewing history and preference data. For instance, a determination may be made to not create a viewing profile for content views that do not seem to fit any identifiable viewing pattern.

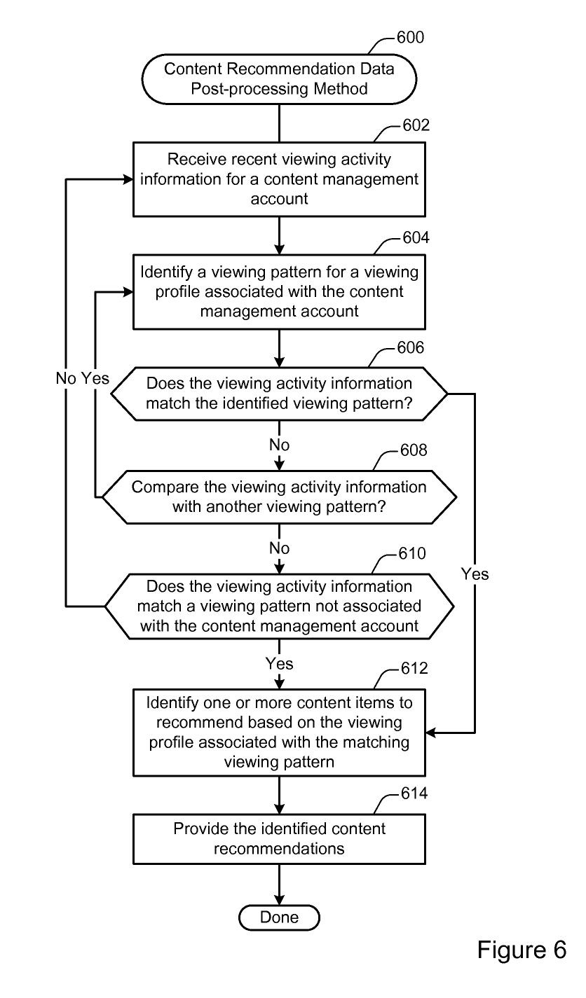

At 412, the viewing profiles are stored in association with the content management account. According to various embodiments, the viewing profiles may be stored in a manner that allows the associated viewing patterns to be compared with viewer actions, as discussed with respect to method 600 illustrated in FIG. 6. The viewing profiles may be stored in a storage system such as a database configured to store profiles and recommendations for retrieval. The recommendations may then be retrieved from the storage system to provide to client machines such as content playback devices.

At 414, a determination is made as to whether to perform profile generation analysis for another content management account. As described with respect to operation 402, profile generation analysis may be performed for any or all of the content management accounts associated with data accessible to the recommendation engine.

FIGS. 5A-5C illustrate examples of charts depicting pre-treated data. According to various embodiments, the charts shown in FIGS. 5A-5C may depict the type of weighting operations that may be performed during pre-processing, as discussed with respect to FIG. 1.

According to various embodiments, each of the data points shown in FIGS. 5A-5C may identify at least a media content item and a content management account. In some cases, data points may identify other information, such as a number of views associated with the content item, a percent of the content item that has been consumed, a time of day that the media content item was viewed, or any other information. For the purposes of illustration, it will be assumed that each of the data points shown in FIGS. 5A-5C is associated with the same content management account.

These charts are presented in order to better elucidate various techniques and mechanisms described herein and need not be actually produced during the recommendation process. Additionally, the data presented on the charts are significantly simplified in comparison with actual data in most recommendation systems. For instance, each of the charts shown in FIGS. 5A-5C includes three data points, while data sets used in many recommendation systems may include hundreds of thousands or even hundreds of millions of data points.

In addition, the pre-processing and transformations shown in FIGS. 5A-5C are only simple examples of the types of pre-processing and transformations that may be performed in accordance with techniques and mechanisms described herein. Specific transformations may in many cases be much more complex. Also, transformations may be strategically determined based on a number of factors, including but not limited to the efficacy of specific transformations in producing reliable recommendations for a given media system, user base, and data set.

In FIG. 5A, the data points are aggregated and weighted by time of day. The chart shown in FIG. 5A includes a Y-axis 502, an X-axis 504, data points 514-518, and a transform 520. FIG. 5A shows an arrangement of the data points and the result of the transformation of the data by a transform function.

The chart shown in FIG. 5A corresponds to a transformation applied to news-related content items. It is anticipated that news-related content items may be time-sensitive in nature. That is, many users may tend to regularly view preferred news-related content such as news broadcast television programs in the morning or evening. In contrast, when users view news-related content at other times, the content may simply reflect some topical interest that does not reflect a strong preference for the content. Accordingly, it is anticipated that news programs viewed during the morning and evening may better reflect a user's preferences and tastes than news-related content viewed at other times. The transform shown in Figure SA may be used to adjust the weighting of content to reflect this anticipated preference pattern.

In particular embodiments, the data points included in a particular transformation need not include all data points available to the system or all data points associated with particular content management accounts. For instance, the transformation shown in FIG. 5A is directed primarily to news-related content, since other content may not reflect time-sensitive preferences in quite the same fashion. Accordingly, the transformation shown in FIG. 5A may be applied to news-related content items but not to other content items.

Each of the data points 514-518 represents a viewing event. Each data point identifies a media content item that was viewed, a content management account that was associated with the viewing, and a time of day that the media content item was viewed. In some cases, each data point may identify additional information. However, not all information associated with each data point is shown in FIG. 5A.

The X-axis 504 represents a time of day at which a content item associated with a data point was viewed. For instance, the media content associated with the data point 514 was viewed in the early morning, around 2:00 am. The media content associated with the data point 516 was viewed in mid-morning, around 9:00 am. The media content associated with the data point 518 was viewed in the early evening, at 6:00 pm.

The Y-axis 502 represents a weighting factor that is assigned by a transform. Prior to transformation, the different data points shown in FIG. 5 were weighted equally and thus treated as having equal significance. That is, each of the views of content items are treated equally when estimating user preferences and identifying unviewed content to recommend for viewing in association with the content management account. After the transformation, different data points may be weighted differently. For instance, in FIG. 5A, content items that were viewed around 6:00 A.M. and 6:00 P.M. may be treated as more significant than other content items.

In FIG. 5B, the data points are aggregated and weighted by the number of times that each content item has been viewed. The chart shown in FIG. 5B includes the X-axis 522, the Y-axis 524, the data points 526-530, and the transformation 532. FIG. 5B shows an arrangement of the data points and the result of the transformation of the data by a transform function.

The chart shown in FIG. 5B represents a view-weighted transformation. It is anticipated that a user who views one content item many times typically prefers it to another content item that the user views only once. Accordingly, the significance of a user's viewing of a content item in the recommendation engine may be weighted by the number of times that the user has viewed the content. For instance, an initial weighting factor may weight each content item by the number of times it was viewed. However, such a weighting may in some instances result in skewed inferences regarding user preferences. For instance, if a user views a content item such as a television news program or a humorous web video clip 60 times, a simple linear weighting factor may unduly skew the results toward content that is similar to the frequently-viewed content. Accordingly, a transformation may be applied that adjusts the weighting factor. For instance, the transformation function may cap the weighting factor at the high and and/or make other adjustments to the weighting factor.

Each of the data points 526-530 represents a viewing event. Each data point identifies a media content item that was viewed, a content management account that was associated with the viewing, and a number of times that the media content item was viewed. In some cases, each data point may identify additional information. However, not all information associated with each data point is shown in FIG. 5B.

In particular embodiments, a media content item need not be an individual media content object such as a video. Instead, a media content item may be a television program, a content channel such as a television channel, or a content genre. Thus, an data point indicating that a media content item was viewed 20 times, for instance, may represent the repeated viewing of a news program or a television channel and not necessarily the repeated viewing of a single media content object. In particular embodiments, the scope of a data point may be changed and/or strategically determine to accommodate various recommendation applications.

The X-Axis 524 represents a number of views associated with each data point. For instance, the data point 526 is associated with a media content item that has been viewed 20 times, the data point 528 with a media content item that has been viewed 10 times, and the data point 530 with a media content item that has been viewed 5 times.

The Y-axis 522 represents a weighting factor that is affected by a transformation. Initially, the weighting factor for a given data point in FIG. 5B is the number of views associated with the content item represented by the data point. For instance, if a media content item is viewed 20 times, then it is assigned a weighting factor of 20, whereas a media content item that has been viewed once would be assigned a weighting factor of 0.

The transformation 532 is applied to the data points to adjust the weighting factors. Initially, the transformation 532 caps the weighting factor that can be applied to any data point at 15. That is, a user may continue to view a media content item more than 15 times, but the view-weight that is applied to the data point does not exceed 15. The transformation 532 then does not affect the weight associated with the data point 528, while it increases the weighting factor associated with the data point 530.

In FIG. 5C, the data points are aggregated and weighted by the percentage of each content item that has been presented. The chart shown in FIG. 5C includes the X-axis 542, the Y-axis 540, the data points 544-548, and the transformation 550. FIG. 5C shows an arrangement of the data points and the result of the transformation of the data by a transform function.

The chart shown in FIG. 5C reflects a percent consumed weighted transformation. It is anticipated that a viewer who views a greater percentage of one content item than another typically, and generally, prefers the first content item to the second. Accordingly, the significance of a data point in a recommendation system may be weighted according to the percentage of the associated content item that was presented to a user. However, it is anticipated that some differences in percentage viewed do not reflect differences in preferences. For instance, the final portion of some content items includes a credits sequence. For this and other reasons, some viewers may simply choose not to view the final portion of a content item. Thus, a viewer who watches 100% of one content item while only viewing 95% of another content item may not actually prefer the first content item to the second. Accordingly, a transformation may be applied to adjust the weighting values to reflect this and other user preferences patterns.

Each of the data points 544-548 represents a viewing event. Each data point identifies a media content item that was viewed, a content management account that was associated with the viewing, and a percentage or portion of the media content item that was viewed or presented. In some cases, each data point may identify additional information. However, not all information associated with each data point is shown in FIG. 5C.

The X-Axis 542 represents a percentage or portion of a content item that was viewed or presented. For instance, the data point 544 is associated with a media content item of which 85% was viewed, the data point 546 with a media content item of which 50% was viewed, and the data point 548 with a media content item of which 25% was viewed.

The Y-axis 544 represents a weighting factor that is affected by a transformation. Initially, the weighting factor for a given data point in FIG. 5B is the percentage of the content item represented by the data point that was presented in association with the content management account. For instance, if 100% of a media content item is presented, then it is assigned a weighting factor of 1, whereas a media content item of which only 25% has been viewed once would be assigned a weighting factor of 0.25.

The transformation 550 is applied to the data points to adjust the weighting factors. Initially, the transformation 550 scales up the weighting factor for media content items for which 75-100% of the item has been presented. That is, if 75-100% of a media content item is presented, then a weighting factor of 1 will be applied, effectively treating the media content item as if 100% of the item had been presented. Accordingly, the weighting factor for the data point 544 is scaled up to 100%. This part of the transformation reflects the idea that if a viewer watches nearly all of a media content item, he or she may be inferred to like it, and that small differences in high viewed percentages likely do not reflect differences in preferences.

Then, the transformation 550 scales the weighting factors for other data points, such as the data point 546. The data point 546 is associated with a content item of which 50% has been viewed, and its weighting factor is scaled down somewhat. This part of the transform reflects the idea that a viewer who stops viewing a content item halfway through may be estimated to have a relatively weak preference for the content item.

Finally, the transformation 550 scales down the weighting factor for media content items for which 0-25% of the item has been presented. For instance, the data point 548 is associated with a media content item of which 25% has been viewed. However, the weighting factor for the media content item is scaled down from 0.25 to 0. This part of the transformation reflects the idea that when a user watches very little of a media content item and then stops viewing it, the viewer may be inferred to not like the content item. Accordingly, small differences in the percentages of content items for which viewing is quickly terminated may not matter in the calculation of new recommendations.

FIG. 6 illustrates a method 600 for content recommendation post-processing. According to various embodiments, the method 600 may be initiated when recommendations are transmitted for presentation at a client machine. For instance, numerical modeling may be performed periodically to produce content recommendations and generate viewing patterns, as discussed with respect to FIGS. 1 and 4. These recommendations may be provided to a viewer when the viewer accesses a content management interface for managing media content via a content management account. The viewer's actions with respect to the media content may be analyzed to provide updated content recommendations based on recent viewing activity.

According to various embodiments, the method 600 may be initiated when viewing activity is detected at the client machine. For instance, recommendations may be sent to a viewer when the viewer begins using a content playback device. Then, when the viewer performs an action such as selecting content for presentation, rating content, or viewing a designated time period or percentage of a content item, the action may be compared with viewing profiles to determine if the viewing activity matches a predetermined viewing pattern.

According to various embodiments, the method 600 may be performed at a media system, such as the systems discussed with respect to FIG. 2 and FIGS. 7-9. The method 600 may be performed in conjunction with a media content recommendation method, such as the method 100 discussed with respect to FIG. 1. For example, various operations discussed in FIG. 6 may act as elaborations or specific instances of operations discussed with respect to FIG. 1, such as operation 112. As another example, various operations discussed with respect to FIG. 6 may be performed in addition to, or instead of, operations discussed with respect to other Figures described herein.

At 604, recent viewing activity information is received for a content management account. According to various embodiments, the recent viewing activity may include viewing history and preference data collected recently, such as within the last hour or in the time period that has elapsed since the most recent iteration of the baseline numerical modeling.

According to various embodiments, the viewing history and preference data may include any information that describes or characterizes the viewer's actions with respect to content management. For example, the viewing history and preference data may include one or more content ratings that are inferred based on viewer actions or that are expressly provided by the viewer. As another example, the data may include information indicating that the viewer has recently selected one or more content items for viewing. As yet another example, the data may indicate a time period or percentage of a content item that was presented to the viewer.

According to various embodiments, the recent viewing history and preference data may include information that has been generated based on recent viewer activity that has not yet been incorporated into numerical modeling and baseline content recommendation calculation. For instance, numerical modeling to perform baseline content recommendation may be performed relatively infrequently, such as once per day, once per hour, or twice per week. However, viewing history and preference data may be collected more frequently, such as whenever the viewer accesses the content management system. Providing conditional content recommendations based on this recent data may allow the recommendation to adapt more quickly to viewer actions, with up-to-date recommendations that reflect the viewer's recent and current viewing activities.

At 604, a viewing pattern for a viewing profile associated with the content management account is identified. According to various embodiments, viewing patterns for a content management account may be generated as discussed with respect to FIG. 4. As discussed with respect to FIG. 4, a content management account may potentially be associated with several different viewing profiles that each corresponds with a different viewing pattern for content viewing activity that has occurred for the content management account. In particular embodiments, viewing profiles may be selected for analysis in any of various orders. For instance, viewing profiles may be selected sequentially or based on a likelihood of a match.

At 606, a determination is made as to whether the viewing activity information matches the identified viewing pattern. According to various embodiments, the determination may be made based on a pattern matching algorithm that determines the degree to which the pattern overlaps with the viewing activity. The type of pattern matching algorithm used as well as the threshold for determining a match may be strategically determined based on factors such as the amount of information available for analysis, the strength of the viewing pattern, and the degree to which the viewing activity matches previously-collected viewing history and preference data.

At 608, a determination is made as to whether to compare the viewing activity information with another viewing pattern associated with the content management account. As discussed with respect to FIG. 4, a content management account may be associated with some number of different viewing profiles, which may be created based on past viewing activity. Some or all of these profiles may be compared with the viewer's recent viewing activity to identify a matching pattern.

In particular embodiments, the viewing activity may in some instances not match a viewing profile associated with the content management account for any of a variety of reasons. For example, the account may be new and may not have a sufficient amount of viewing history or preference data to create a viewing profile. As another example, a viewing associated with the account may suddenly begin exhibiting behavior out of character with previous activity for the account. For instance, an account may have always been associated with content typically viewed by adults. Then, the content being selected in association with the account may suddenly switch to children's movies and television programs. This change may reflect the fact that an adult recently provided access to the account to a child who did not previously use the account. In this and other cases, as discussed with respect to operation 610, the viewing activity may be compared with viewing patterns not associated with the content management account.

At 610, a determination is made as to whether the viewing activity information matches a viewing pattern not associated with the content management account. According to various embodiments, the determination may be made by comparing the viewing activity information with other viewing patterns, such as generic baseline patterns or viewing patterns associated with other content management accounts.

In particular embodiments, the determination made at operation 610 may be made at least in part by comparing the viewing activity associated with the content management account with viewing patterns for viewing profiles associated with other content management accounts. For instance, the viewing activity may be compared to viewing patterns associated with other accounts that have similar viewing history or preference data.

In particular embodiments, the determination made at operation 610 may be made at least in part by comparing the viewing activity with one or more baseline viewing profiles. One or more baseline viewing profiles may be determined based on aggregated viewing history or preference data. For instance, one generic baseline profile may identify content that is often preferred by children. Another generic baseline profile may identify content that is often enjoyed by users who seem to be sports enthusiasts. Yet another generic baseline profile may identify content that is often selected by users who are viewing currently popular television shows.

At 612, one or more content items to recommend based on the viewing profile associated with the matching viewing pattern are identified. According to various embodiments, a viewing profile may be associated with content recommendations when the viewing profile is generated. For instance, numerical modeling performed as discussed with respect to FIGS. 1 and 4 may identify content items that a viewer associated with a particular viewing profile is likely to enjoy. These content items may then be recommended to a viewer whose viewing activity matches the viewing profile without needing to perform additional modeling. Accordingly, the content items may be identified by retrieving recommendations from a storage system.

A recommended media content item associated with a viewing pattern may be any individual media object, media category or genre, or media channel capable of being analyzed by the recommendation system. For example, a media content item may be an individual piece of content such as a video object. As another example, a media content item may be a standardized content channel such as a television channel or a personalized content channel created by the media system. As yet another example, a media content item may be a content category such as a genre.

In particular embodiments, not all of the content items recommended need be based on the matching viewing profile. In some cases, a viewer may be provided with other content recommendations for any of a variety of reasons. For example, the recommendation engine may have incorrectly identified a viewer's viewing profile. As another example, the viewer may be provided with other recommendations in case the viewer's viewing pattern changes. For instance, an adult using a portable media presentation device such as a tablet computer could hand the tablet computer to a child, so some number of recommendations not associated with the current pattern of viewing activity may be provided. As yet another example, a viewer exhibiting a particular viewing pattern may be provided with recommendations from the baseline recommendation set associated with a content management account as well as with recommendations associated with the viewer's current viewing pattern. For instance, a viewer may be primarily watching sports-related programming but may be interested in seeing recommendations for other content, such as dramatic films or television programs.

At 614, the identified content recommendations are provided. According to various embodiments, providing the content recommendation may involve transmitting the content recommendation to a client machine for presentation in a user interface. For instance, a user interface at a client machine may be configured to allow a user to view, select, search, and otherwise manage content items. The content recommendations presented in the interface may be updated based on the operations discussed with respect to FIG. 6. In this way, the viewer may be provided with up-to-date content recommendations based on recent viewing history and preference data, such as data received within the last hour or day, that may not have been fully incorporated into the latest round of numerical modeling.

In particular embodiments, more than one content recommendation may be provided when the viewing activity matches the viewing pattern. For example, the viewing profile may be associated with children's programming. When the viewing pattern associated with the profile is matched, the viewer may be presented with recommendations for a variety of children's content such as cartoons, Disney movies, and children's television programs.

According to various embodiments, the operations related to post-processing content recommendation data may be performed in an order different than that shown in FIG. 6. For example, instead of analyzing viewing patterns until a match is determined, viewing activity may be compared with potentially many different viewing patterns to determine the best match. For instance, viewing activity may be compared with each viewing pattern associated with a content management account.

FIG. 7 is a diagrammatic representation illustrating one example of a fragment or segment system 701 associated with a content server that may be used in a broadcast and unicast distribution network. Encoders 705 receive media data from satellite, content libraries, and other content sources and sends RTP multicast data to fragment writer 709. The encoders 705 also send session announcement protocol (SAP) announcements to SAP listener 721. According to various embodiments, the fragment writer 709 creates fragments for live streaming, and writes files to disk for recording. The fragment writer 709 receives RTP multicast streams from the encoders 705 and parses the streams to repackage the audio/video data as part of fragmented MPEG-4 files. When a new program starts, the fragment writer 709 creates a new MPEG-4 file on fragment storage and appends fragments. In particular embodiments, the fragment writer 709 supports live and/or DVR configurations.

The fragment server 711 provides the caching layer with fragments for clients. The design philosophy behind the client/server application programming interface (API) minimizes round trips and reduces complexity as much as possible when it comes to delivery of the media data to the client 715. The fragment server 711 provides live streams and/or DVR configurations.

The fragment controller 707 is connected to application servers 703 and controls the fragmentation of live channel streams. The fragmentation controller 707 optionally integrates guide data to drive the recordings for a global/network DVR. In particular embodiments, the fragment controller 707 embeds logic around the recording to simplify the fragment writer 709 component. According to various embodiments, the fragment controller 707 will run on the same host as the fragment writer 709. In particular embodiments, the fragment controller 707 instantiates instances of the fragment writer 709 and manages high availability.

According to various embodiments, the client 715 uses a media component that requests fragmented MPEG-4 files, allows trick-play, and manages bandwidth adaptation. The client communicates with the application services associated with HTTP proxy 713 to get guides and present the user with the recorded content available.

FIG. 8 illustrates one example of a fragmentation system 801 that can be used for video-on-demand (VoD) content. Fragger 803 takes an encoded video clip source. However, the commercial encoder does not create an output file with minimal object oriented framework (MOOF) headers and instead embeds all content headers in the movie file (MOOV). The fragger reads the input file and creates an alternate output that has been fragmented with MOOF headers, and extended with custom headers that optimize the experience and act as hints to servers.

The fragment server 811 provides the caching layer with fragments for clients. The design philosophy behind the client/server API minimizes round trips and reduces complexity as much as possible when it comes to delivery of the media data to the client 815. The fragment server 811 provides VoD content.

According to various embodiments, the client 815 uses a media component that requests fragmented MPEG-4 files, allows trick-play, and manages bandwidth adaptation. The client communicates with the application services associated with HTTP proxy 813 to get guides and present the user with the recorded content available.

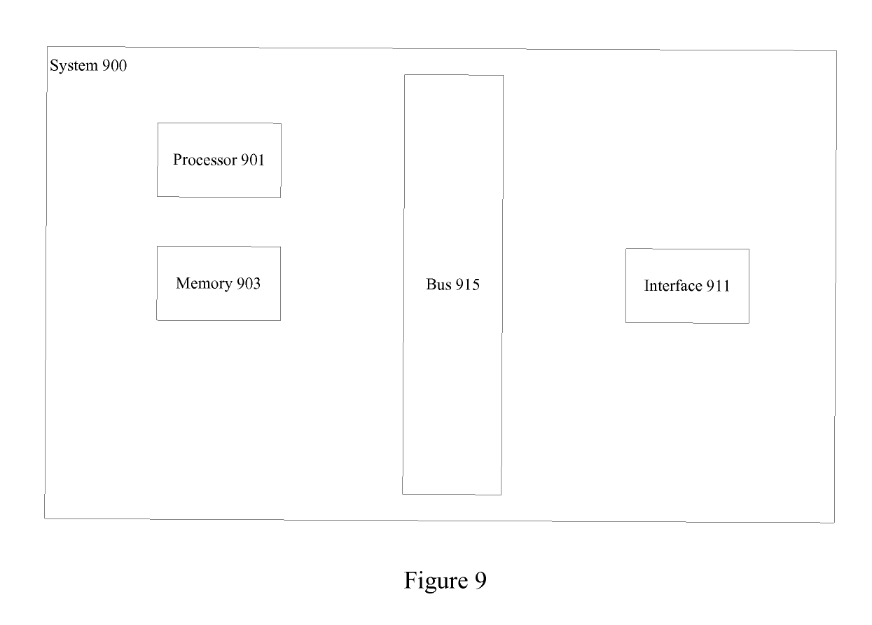

FIG. 9 illustrates one example of a server. According to particular embodiments, a system 900 suitable for implementing particular embodiments of the present invention includes a processor 901, a memory 903, an interface 911, and a bus 915 (e.g., a PCI bus or other interconnection fabric) and operates as a streaming server. When acting under the control of appropriate software or firmware, the processor 901 is responsible for modifying and transmitting live media data to a client. Various specially configured devices can also be used in place of a processor 901 or in addition to processor 901. The interface 911 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 900 is a server that also includes a transceiver, streaming buffers, and a program guide database. The server may also be associated with subscription management, logging and report generation, and monitoring capabilities. In particular embodiments, the server can be associated with functionality for allowing operation with mobile devices such as cellular phones operating in a particular cellular network and providing subscription management capabilities. According to various embodiments, an authentication module verifies the identity of devices including mobile devices. A logging and report generation module tracks mobile device requests and associated responses. A monitor system allows an administrator to view usage patterns and system availability. According to various embodiments, the server handles requests and responses for media content related transactions while a separate streaming server provides the actual media streams.

Although a particular server is described, it should be recognized that a variety of alternative configurations are possible. For example, some modules such as a report and logging module and a monitor may not be needed on every server. Alternatively, the modules may be implemented on another device connected to the server. In another example, the server may not include an interface to an abstract buy engine and may in fact include the abstract buy engine itself. A variety of configurations are possible.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method comprising:
receiving information identifying one or more viewing events or actions detected in association with a designated content management account at a media system, the designated content management account providing access to a plurality of media content items via the media system, the designated content management account being associated with a viewing profile, the viewing profile designating one or more of the plurality of media content items for recommendation in association with the designated content management account, the viewing profile also designating a pattern of viewing activity for recommending the designated media content items; and
when the identified viewing events or actions match the designated pattern of viewing activity, transmitting a message to the client machine, the message comprising an instruction for recommending the designated media content items for presentation.

2. The method recited in claim 1, the method further comprising:
creating the viewing profile by numerically modeling input data, the input data describing the presentation of a plurality of presented media content items in association with a plurality of content management accounts, the plurality of content management accounts including the designated content management account.

3. The method recited in claim 2, wherein the input data comprises a plurality of data points, each of the data points identifying a respective one of the presented media content items presented in association with a respective one of the content management accounts.

4. The method recited in claim 2, wherein creating the viewing profile comprises:
identifying the pattern of viewing activity based on the input data.

5. The method recited in claim 4, wherein creating the viewing profile further comprises:
selecting the designated media content items to match the pattern of viewing activity.

6. The method recited in claim 1, wherein each of the designated media content items is associated with a respective estimate of a preference for the media content item, the estimate of the preference being associated with the designated content management account.

7. The method recited in claim 1, wherein the designated media content item is an item selected from the group consisting of: a video object, a media content genre, a media content category, and a media content channel.

8. The method recited in claim 1, wherein each or selected ones of the media content items comprises a streaming video capable of being transmitted from a server to a client machine via a network.

9. A system comprising:
a storage system operable to store information identifying one or more viewing events or actions detected in association with a designated content management account at a media system, the designated content management account providing access to a plurality of media content items via the media system, the designated content management account being associated with a viewing profile, the viewing profile designating one or more of the plurality of media content items for recommendation in association with the designated content management account, the viewing profile also designating a pattern of viewing activity for recommending the designated media content items;
a processor operable to determine whether the identified viewing events or actions match the designated pattern of viewing activity; and
a network interface operable to transmit a message to the client machine when the identified viewing events or actions match the designated pattern of viewing activity, the message comprising an instruction for recommending the designated media content items for presentation.

10. The system recited in claim 9, wherein the processor is further operable to:
create the viewing profile by numerically modeling input data, the input data describing the presentation of a plurality of presented media content items in association with a plurality of content management accounts, the plurality of content management accounts including the designated content management account.

11. The system recited in claim 10, wherein the input data comprises a plurality of data points, each of the data points identifying a respective one of the presented media content items presented in association with a respective one of the content management accounts.

12. The system recited in claim 10, wherein creating the viewing profile comprises:
identifying the pattern of viewing activity based on the input data.

13. The system recited in claim 12, wherein creating the viewing profile further comprises:
selecting the designated media content items to match the pattern of viewing activity.

14. The system recited in claim 9, wherein each of the designated media content items is associated with a respective estimate of a preference for the media content item, the estimate of the preference being associated with the designated content management account.

15. The system recited in claim 9, wherein the designated media content item is an item selected from the group consisting of: a video object, a media content genre, a media content category, and a media content channel.

16. The system recited in claim 9, wherein each or selected ones of the media content items comprises a streaming video capable of being transmitted from a server to a client machine via a network.

17. One or more non-transitory computer readable media having instructions stored thereon for performing a method, the method comprising:
receiving information identifying one or more viewing events or actions detected in association with a designated content management account at a media system, the designated content management account providing access to a plurality of media content items via the media system, the designated content management account being associated with a viewing profile, the viewing profile designating one or more of the plurality of media content items for recommendation in association with the designated content management account, the viewing profile also designating a pattern of viewing activity for recommending the designated media content items; and
when the identified viewing events or actions match the designated pattern of viewing activity, transmitting a message to the client machine, the message comprising an instruction for recommending the designated media content items for presentation.

18. The one or more computer readable media recited in claim 17, the method further comprising:
creating the viewing profile by numerically modeling input data, the input data describing the presentation of a plurality of presented media content items in association with a plurality of content management accounts, the plurality of content management accounts including the designated content management account.

19. The one or more computer readable media recited in claim 18, wherein the input data comprises a plurality of data points, each of the data points identifying a respective one of the presented media content items presented in association with a respective one of the content management accounts.

20. The one or more computer readable media recited in claim 18, wherein each of the designated media content items is associated with a respective estimate of a preference for the media content item, the estimate of the preference being associated with the designated content management account.
